(19) United States
(12) Patent Application Publication
(10) Pub. No.: US 2010/0038040 A1
(43) Pub. Date: Feb. 18, 2010

(54) Expandable modular screen system

(76) Inventor: Kiril Korov, Brooklyn, NY (US)

Correspondence Address: Andrew A. Anissi, Suite 2, 43 7th Avenue, Brooklyn, NY, 11217, US

(21) Appl. No.: 12/462,499

(22) Filed: Aug. 4, 2009

Related U.S. Application Data
(60) Provisional application No. 61/137,861, filed on Aug. 4, 2008.

(51) Int. Cl. E06B 9/24

(52) U.S. Cl. 160/130

(57) ABSTRACT

An expandable modular screen system with a plurality of modules, each such module having at least three sides. Each of the sides is substantially equal in length and has a loop extending away from its module. Each of the loops can link to a loop on an adjacent module by receiving the other loop or being received by the other loop.

### RELATED APPLICATION

This application claims priority from U.S. Provisional Patent Application No. 61/137,861 filed on Aug. 4, 2008, the entirety of which is incorporated herein by reference.

### FIELD OF THE INVENTION

The present invention is directed toward a modular screen system with seamless rotational changeability of segments (i.e. modules or panels).

### BACKGROUND

There are many strategies available for adding patterns, textures, and screens to transform interior spaces, from wall panels to room dividers. For example, some technologies use free-standing units of connectable materials as partitions, or others used patterned tiles that attach to the wall. Some hanging materials use long panels that hook together using screws or screw-like connections.

It is well known in the art to build a dividing screen by connecting together a matrix of modules. Prior attempts generally mount individual modules on a deck or other support system. See, for example, U.S. Pat. Nos. 5,248,043; 5,346,053; 5,372,261; 6,306,200; 6,253,926; 6,267,246; 6,830,155; 7,090,083; and 7,188,457.

Other attempts at creating modular screens use frames or extraneous fastening members attached to adjacent modules to connect them together. See for example, U.S. Pat. Nos. 3,987,836; 4,185,430; 4,909,929; 4,928,465; and 5,213,217.

The prior attempts at building modular screens are limited in efficiency for aesthetic possibility as well as for the ability to quickly assemble, disassemble, reconfigure, or replace all or part of such screens.

### SUMMARY AND OBJECT OF THE INVENTION

The present invention is directed to a functional, expandable modular screen system for decoration or division of space in residential or commercial spaces, without the use of frames, backing, posts, or other extra objects to connect individual screen modules.

It is another object of the invention to provide a modular screen system that is easy to assemble and disassemble by allowing rotations of individual screen modules without disrupting the screen system created by a matrix of interconnected screen modules.

In particular, the present invention's screen system embodies multiple units (also referred to as “modules” or “panels”), with each unit attachable to other such units at each of its ends on a common place, such units each bearing the same or different designs, customizable according to the choice of the user and manufacturer, such that designs may be made continuous and expandable by adding additional units. The units in the system's unique linking system are interchangeable and the system itself is expandable by the simple means of linking further units to the system. This allows for freedom of design solutions with easy assembly.

An embodiment of a unit of the present invention is manufactured in a flexible material with attachment links on each of its sides on a common plane, so that a user of such units can attach two of such units together inserting a link on any side of a unit with a link on any side of a second unit. The system is expandable depending upon how many units a user chooses to link together.

An important feature of the present invention is that its units may be rotated by a standard rotation and attached to other units in the system, without affecting the system, except for the design, which would also not be affected in embodiments having symmetrical units. A standard rotation, in this context, is a rotation in degrees equal to 360*(1/number of sides of unit along a common plane). For example, an embodiment of the system having four-sided units, such as those shown in FIGS. 1 through 3, a standard rotation would be 90 degrees. The rotation may be clockwise or counterclockwise from the two-dimensional perspective shown in FIGS. 1 through 3. In a typical embodiment of the system, the design of the units is such that design elements at each of the ends (on a common plane) will connect to design elements of an adjacent unit regardless of whether or not the first unit first undergoes any number of standard rotations.

Some embodiments of the present invention includes units each being made with exactly four sides on a common plane, with a two-dimensional design in the middle. However, the present invention is not limited to systems having units with exactly four sides (on a common plane), but in a particular system, it is preferable that units to be used in such system be manufactured with the same number of sides. For example, another embodiment of the present invention is a system of units each having five sides on a common plane.

In preferred embodiments of the expandable modular screen system the modules are made of a lightweight, pliable material, such as custom ethylene vinyl acetate (EVA) plastic material.

### BRIEF DESCRIPTION OF THE DRAWINGS

FIG. 1 shows two units (i.e. modules) 2 of the present invention, and how they may be attached together as at 3 to create an expandable system (a matrix) 4, using loops 1 to link multiple units 2 together. FIG. 1 shows units 2 with a particular design in the middle each.

FIG. 2 shows a matrix 4 of the present invention including a larger number of units 2 than shown in FIG. 1. FIG. 2 shows a continuous pattern created by an expanded system of linked units 2. FIG. 2 shows attachment brackets 5 which may be used to attach the system to a horizontal or vertical surface, or else on a horizontal or vertical wire, to hold the system in place.

FIG. 3, at 6A shows three units of the present invention, all with the same design aligned in the same direction, linked together. 6B shows the same three units, after first being rotated 90 degrees clockwise, then linked together. 6C shows the same three units each being rotated clockwise at a random multiple of 90 degrees, and then being linked together. Each of 6A, 6B, and 6C shows different functional uses of the units in the present system.

FIG. 4 shows an embodiment of the present invention with attachment hooks 5a that wrap around a unit's loop 1 at the end of a modular screen system. The attachment hooks themselves are connected directly to a wall or ceiling, as brackets.

FIG. 5 shows an embodiment of the present invention with a different type of brackets from that shown in FIG. 4. Attachment hooks 5b hook the loops 1 at the end(s) of a modular screen system. The attachment hooks 5b connect to the connectors 7, which connect to the wall or ceiling.

FIG. 6 shows an embodiment of the present invention wherein design connections 8 are each set at a standard spacing on the sides of modules 2 of the system, to allow design connections 8 to connect to one another to create a continuous design across the system.

FIG. 7 shows a single square module with loops 1 extending from the center of each of its four sides on a common plane.

### DETAILED DESCRIPTION OF THE DRAWINGS

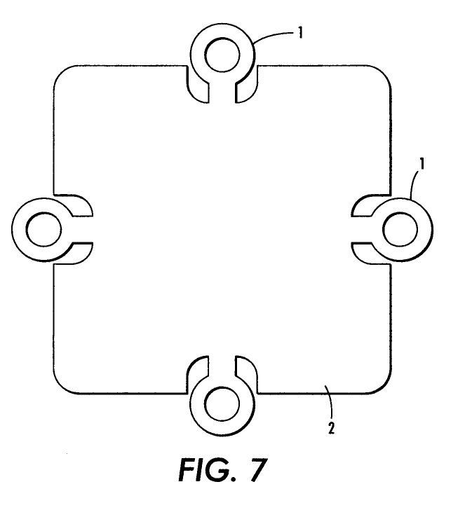

A simple version of a single module 2 of the expandable modular screen system is shown in FIG. 7. It is clear from FIG. 7 that the positions of each loop 1 does not change when the module 2 undergoes a standard rotation as defined above. This is because each loop 1 is positioned at a corresponding point on each side of the module 2, and each of the sides is of substantially the same length.

Though the drawings show square modules and screen systems each made up in form of matrix 4 connected only vertically or horizontally, it is understood that the present invention is not limited to modules having exactly four sides on a common plane and four loops, such as that shown in FIG. 7. Rather, an expandable modular screen system according to the present invention may have any number of sides as is practical for use in a modular screen system. For example, while the FIG. 7 module 2 appears as a four sided/square module, a system may be made up of three sided/triangular modules or five sided/pentagonal modules. However, four sided modules seem to be optimal in terms of practicality.

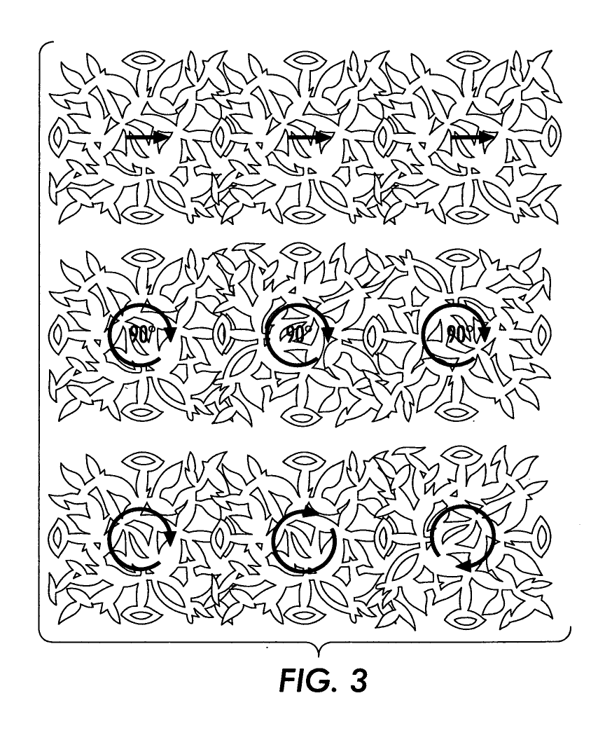

In general, no matter whether a module 2 of the present invention is square, triangular, pentagonal, or having any other number of sides, it is preferable that all of the sides on a common plane be of substantially the same length. For example, matrix 4 of square modules as described herein is preferable to rectangular module with an unequal height and width, because the matrix 4 of square modules would not be disrupted by a standard rotation of a particular square module, as shown in FIG. 3.

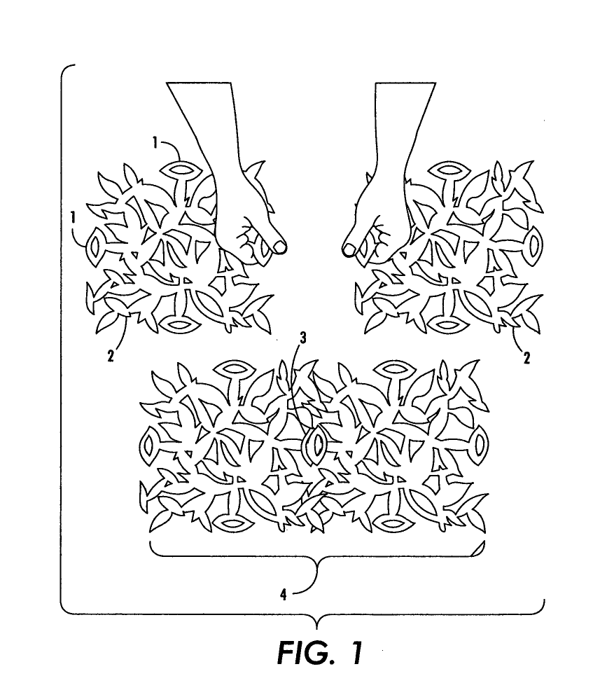

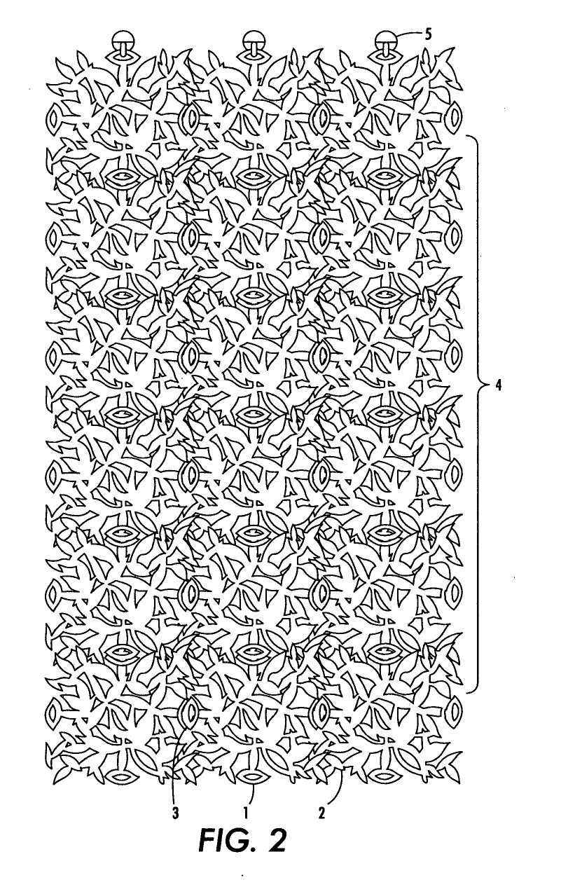

It is also understood that the sides of each module 2 should not be construed to require continuous/flat edges, as in the module 2 depicted in FIG. 7. Some embodiments of a module may have sides with cut gaps, based on the aesthetic design, such as the modules depicted in FIGS. 1-3 and FIG. 6.

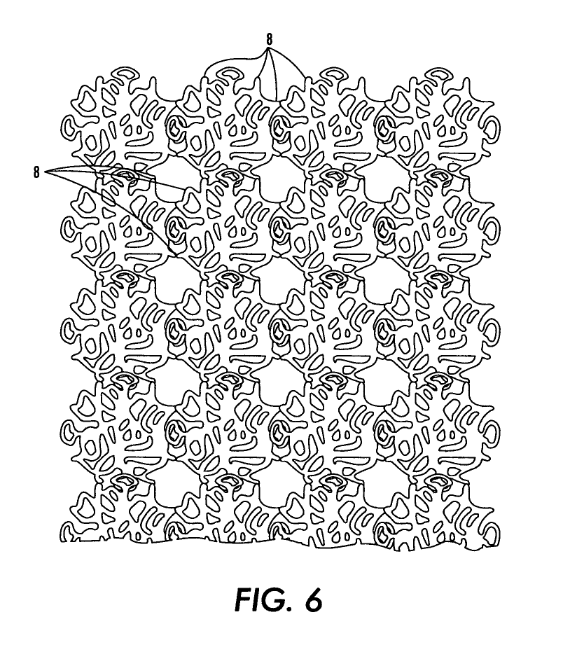

In some embodiments of the present invention, the designs have particular, common connecting design connector points 8 on each the side of a unit along a common plane, so that designs may be made continuous along an expanded modular screen matrix 4, no matter how many standard rotations each unit undergoes before connecting to other units, as shown in FIG. 6. The design connector points 8 are set at standard spacings on each unit to ensure that they always correspond to design connector points 8 on other units that the module 2 connects to. This allows there to be continuity of designs across multiple modules, regardless of how many standard rotations each module has undergone.

The rotations and connector points may be understood geometrically as follows.

n is an integer≧3,

p is any integer where n≧p≧1,

the number of sides of a module for a particular expandable screen is equal to exactly n. Note that all of the modules of a particular expandable screen should have the same number of sides.

a (x,y) Cartesian plane is defined as intersecting all of the sides of a module. Note that for a particular expandable screen system, all modules will be arranged and connected on the same plane.

a z-axis is perpendicular to the (x,y) Cartesian plane,

a standard rotation of a module about the z axis is equal to 360°/(n). So for a square module having four sides (n=4), a standard rotation is 90°.

Each design connector point 8 on a side of a module is positioned at a standard position relative to the module. Each such design connector point 8 should have a matching design connector point 8 on each other side of the module, such that after p standard rotations there will be connector points 8 at the same positions.

A matrix 4 of individual modules 2 is built by connecting a plurality of modules 2 by connecting the loop 1 of one module 2 to the loop 1 of an adjacent module 2. To connect two of the loops 1 together, one loop may be pinched and pushed through the hole of another loop, to create an interlocking connection 3 between the loops. In this way, each loop 1 can be either the lock or the key. The loops 1 may be connected in this way because the modules 2 are made of a flexible material, while the shape of the loop springs back and locks the loop 1 into place after the loop 1 is pinched and pushed through the hole of another loop 1.

Each of the loops 1 can link to a loop 1 on another module by receiving another loop or being received by another loop. For the first loop to be received by a second loop, the first loop should be pinched and pushed through the hole of the second loop. For the first loop to receive a second loop, the second loops should be pinched (squeezed) and pushed through the first loop. The loops of course must be shaped in such a way that this method will cause them to lock when one loop receives another and the other is no longer being pinched/squeezed.

FIG. 3 at 6A shows an array of modules 2 with interlocked connections 3 between loops 1. An expandable modular screen formed by a matrix 4 (or an array) of modules 2 is made of many various modules 2, each of which may be rotated by a standard rotation, as defined above, without disrupting the matrix 4, as shown in FIG. 3. 6B of FIG. 3 shows how the individual modules 2 of an array of modules can be rotated by a standard rotation, and the array of modules can still be connected to make an expandable modular screen system. In FIG. 3, the modules each have four sides on a common plane, and so a standard rotation is 360 degrees/4, which is equal to 90 degrees. FIG. 3 at 6C shows the same array wherein each module 2 is rotated by a different number of standard rotations. The first module of 6C is rotated by 90 degrees, the second by 270 degrees, and the third by 180 degrees. But because the loops 1 are interchangeable, and because the connector points 8 of the design are at the same standard positions, the modules may form connections 3 in the same direction (horizontally in this case), via the modules' loops 1, to form a continuous array of modules 2 as part of an expandable modular screen system.

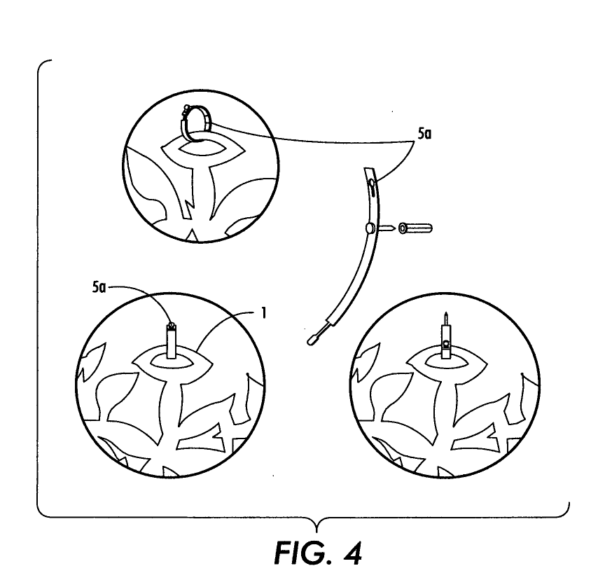

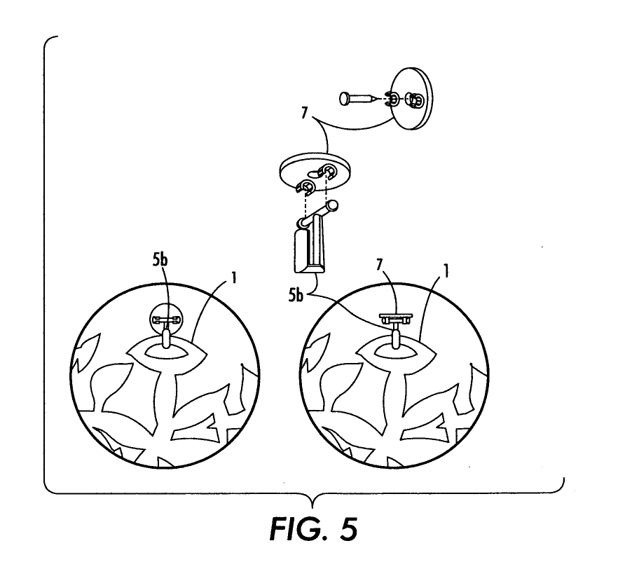

FIGS. 4-5 show examples of how a matrix 4 of modules 2 may be mounted or attached to a ceiling or other surface, using attachment brackets shown in 5a and 5b, to create a functional expandable modular screen system, which can be used to divide spaces. In FIG. 4, an attachment hook 5a is slipped through a loop 1 on a module and wraps around the loop 1. The attachment hook 5a can then be attached to a surface such as a wall or ceiling. FIG. 5 shows a different type of brackets from FIG. 4. In FIG. 5, attachment hooks 5b hook each loop 1 and connect to connectors 7, which in turn attach to a surface such as the wall or ceiling.

While only certain features of the invention have been illustrated and described herein, many modifications, changes, and equivalents will now occur to those skilled in the art. It is to be understood that this application is intended to cover all such modifications, changes, and equivalents that fall within the spirit of the invention.

I claim:

1. an expandable modular screen system comprising a plurality of modules, each such module comprising at least three sides,
wherein each of said at least three sides is substantially equal in length and has a loop extending away from said module,
wherein each of said loops can link to a loop on an adjacent module.

2. the expandable modular screen system of claim 1, wherein said module further comprises a lightweight, pliable material.

3. the expandable modular screen system of claim 2, further comprising brackets attached to the vertically highest of said modules, said brackets being attachable to a wall or ceiling.

4. the expandable modular screen of claim 2 wherein each of said modules further comprises an aesthetic design and at least one design connector point on a first side of said module, each of said design connector points having a corresponding design connector point on each other side of said module, positioned such that any number of standard rotations will always put said module in a position such that there will be a design connector point in the same position as said at least one design connector point's position before said standard rotations.

5. a module for an expandable modular screen system comprising a lightweight, pliable material and at least three sides, wherein each of said at least three sides is substantially equal in length and has a loop extending away from said module, and wherein each of said loops can link with a loop on a second such module.

6. a module as described in claim 5, further comprising an aesthetic design, a first design connector point on a first side of said at least three sides of said module, and a design connector point corresponding with said first design connector point on said first side, positioned such that any integral number of standard rotations of said module will always ensure that either said first design connector point or one of said corresponding design connector points will be located in the same position as said first design connector point's position before said standard rotations.
